(19) United States
(12) Patent Application Publication
(10) Pub. No.: US 2010/0084588 A1
(43) Pub. Date: Apr. 8, 2010

(54) Deepwater Hydraulic Control System

(75) Inventors: Jason Post Curtiss, III, Houston, TX (US); John Stephen Hiltpold, Sugar Land, TX (US); Patrick D.M. Rogan, New Orleans, LA (US); Harris A. Reynolds, JR., Houston, TX (US)

Correspondence Address: AKIN GUMP STRAUSS HAUER & FELD LLP, 1111 Louisiana Street, 44th Floor, Houston, TX, 77002, US

(73) Assignee: DIAMOND OFFSHORE DRILLING, INC., Houston, TX (US)

(21) Appl. No.: 12/554,374

(22) Filed: Sep. 4, 2009

Related U.S. Application Data
(60) Provisional application No. 61/103,416, filed on Oct. 7, 2008.

(51) Int. Cl. F16K 31/12

(52) U.S. Cl. 251/57

(57) ABSTRACT

A hydraulic control system and method utilizing a retrievable control pod for the actuation of subsea blowout preventer stacks are disclosed. In one embodiment, the hydraulic control system comprises a subsea hydraulic umbilical line, a lower marine riser package having a hydraulic receptacle, a hydraulic control pod having a hydraulic connector for hydraulically mating with the hydraulic receptacle, at least one pod umbilical hydraulic connector hydraulically connected through umbilical connector piping to the hydraulic control pod, and at least one lower marine riser package umbilical hydraulic connector for hydraulically mating with the pod umbilical hydraulic connector and the subsea hydraulic umbilical line.

### CROSS-REFERENCE TO RELATED APPLICATIONS

None.

### STATEMENTS REGARDING FEDERALLY SPONSORED RESEARCH OR DEVELOPMENT

None.

### REFERENCE TO A MICROFICHE APPENDIX

None.

### BACKGROUND OF THE INVENTION

1. Field of the Invention

The present invention relates to an improved hydraulic control system for actuation of subsea equipment in deep water, particularly for the actuation of subsea Blowout Preventer (BOP) stacks.

2. Description of the Related Art

Safety considerations in offshore drilling dictate that a subsea blowout preventer (BOP) must be able to rapidly close-off the well bore regardless of the water depth at the drilling location. Industry standards (such as those of the American Petroleum Institute (API) and the US Minerals Management Service (MMS)) require that annular BOPs close within 60 seconds and ram BOPs within 45 seconds. In the interests of improved safety, however, it is an industry goal to execute these critical functions as fast as practically possible.

In addition, industry standards may also require that dynamically-positioned drilling vessels (that is, floating vessels which aren't moored during normal drilling operations) which may accidentally “drift-off” or intentionally “drive-off” their normal operating positions must be able to execute an “Emergency Sequenced Disconnect” which requires multiple command and feedback signals be executed in a sequenced manner so that “BOP close” and “riser disconnect” functions occur in an orderly and rapid manner before the rig deviates too far from its normal operating position.

Prior-art control systems for subsea equipment, particularly BOPs, include hydraulic control systems (including “straight” hydraulic systems and systems with pilot-operated valves) and electro-hydraulic systems, in which all or some hydraulic functions are controlled electrically.

Subsea control systems, whether hydraulic, electro-hydraulic, or multiplexed (MUX) systems, can be divided into three parts: the signal subsystem, which converts a signal at the surface into hydraulic pilot signal at a valve proximate the seabed (typically an SPM valve), the actuation subsystem, which uses hydraulic pressure to actuate the subsea equipment (for example, blowout preventers or valves) on receipt of an hydraulic pilot signal from the Signal subsystem part of the control system, and the monitoring subsystem, which provides an indication on the surface that the subsea equipment has been properly actuated.

The monitoring subsystem in a hydraulic control system may comprise an umbilical hose which transmits manifold pressure to a pressure gauge on the surface. In an electro-hydraulic control system, the monitoring subsystem may comprise an electrical signal to the surface which transmits manifold pressure and/or an indication of the position of the equipment (e.g. the position of the ram in a ram-type BOP).

The signal subsystem of a prior-art hydraulic subsea control systems may send a hydraulic signal from the surface directly to the SPM valves in a subsea control pod to actuate the subsea equipment (a so-called “straight” hydraulic system). Alternately, a “pilot-valve” system may comprise shear-seal pilot-operated valve in the control pod which, upon receipt of a hydraulic signal from the surface, will send a hydraulic signal from subsea accumulators to the SPM valves. One advantage of a pilot-valve system is that the hydraulic fluid send to the SPM valves is stored subsea in accumulators, which typically reduces response time.

The signal subsystem of prior-art electro-hydraulic system (including MUX systems) will typically use solenoid-operated shear-seal valves to send a hydraulic signal to the SPM valves.

These valves, regardless of the control system type, are typically located in a “pod” mounted on the Lower Marine Riser Package (LMRP), which is a separable part of the subsea BOP stack, located at the top of the stack, and typically connected to the drilling riser through a flexible joint. The hydraulic pilot signal from the pilot valves is typically conveyed to the main part of the BOP stack through a separable hydraulic “stab” assembly which allows the riser, flexible joint and LMRP to be disconnected from the BOP stack in an emergency.

In the prior art, there are also various differential pressure, or pulsed, or matrix hydraulic systems which can which can control more than one function per control line; see, for example, U.S. Pat. No. 3,993,100 to Pollard, et al, U.S. Pat. No. 4,497,369 to Hurta, et al, and U.S. Pat. No. 4,407,183 to Milberger, et al. These patents are incorporated in the current disclosure by reference in their entirety for all purposes. Most conventional hydraulic subsea control systems in use today, however, are so called “discrete” systems, in which each function has a dedicated hydraulic conduit between surface and seabed.

In “discrete” electro-hydraulic control systems, each control function has at least one discrete wire between the surface and the seabed (often with a common ground). The most common modern electro-hydraulic control systems, however, are “multiplex” (or MUX) systems in which digital “multiplexed” control signals are transmitted along electrical or optical conductors (usually within the umbilical bundle) from the surface to the seabed, where the digital signals are interpreted to control hydraulic functions.

Hydraulic systems are generally understood to be cheaper and more robust than electro-hydraulic systems. Hydraulic systems, for example, generally have higher up-time, are easier to diagnose, require fewer spare parts, and can be repaired in the field by non-specialized workers. A recent study by the present inventors, for example, revealed that MUX BOP control systems have an initial cost about 4 times that of a hydraulic system, and, over a 5-year period, average about 1.8 times more downtime. Since downtime on a modern floating drilling rig can today cost on the order of $20,000 per hour, the increased downtime of MUX control systems has become a significant issue.

In deep water, however, prior-art hydraulic BOP control systems can experience unacceptable delays in subsea BOP response time, in large part because (A) the time required to send a hydraulic activation signal through an umbilical hose from the surface control station to the subsea controls (the “signal time”), becomes excessively long in deep water, and (B) the time required for manifold pressure to travel up an umbilical hose to the surface to a pressure gauge, to provide indication that the subsea equipment has properly actuated (the “monitoring time”), may also become excessively long in deep water.

As used herein, the term “signal time” means the time from an initial signal on the surface until a required activation pressure controlling the subsea equipment is achieved at the seabed. In straight hydraulic control systems, the signal time will be the time for the hydraulic pressure at the seabed to rise to the required actuation pressure for the SPM valves. In hydraulic control systems with pilot-operated control valves, the signal time may also include the time required to actuate the pilot-operated valves which supply the required actuation pressure for the SPM valves.

As used herein, the term “monitoring time” means the time from an indication of equipment actuation on the seabed (e.g. a rise in manifold pressure) until that indication appears at the surface. In electro-hydraulic systems, monitoring time may be very short as the monitoring signals are transmitted electrically, but in hydraulic control systems, the monitoring time may be on the order of 15-20 seconds in deep water.

As used herein, the term “response time” means the time from an initial signal at the surface until an indication of the required equipment response (for example, a subsea BOP closing off a wellbore during drilling operations, or a gate-valve shutting-in a producing well) is received at the surface. In other words, signal time and monitoring time are subsets of response time.

It has been long taught in the prior art that the signal time in an all-hydraulic deepwater control system may be reduced by the use of umbilical hose with a larger ID, following the reasoning that a larger diameter hose will have a higher Flow Coefficient (commonly abbreviated as Cv, where Cv is defined as the flow, in gallons per minute of water at 60 degrees F., with a pressure drop of 1 psi), to allow hydraulic fluid to flow more efficiently to the control valves near the seabed. For example, U.S. Pat. Nos. 5,070,904 to McMahon, et al and 6,484,806 to Childers, et al teach reducing signal time in hydraulic subsea BOP control systems by increasing the size of the control hoses, and therefore increase the flow coefficient (or Cv) of the hoses. However, larger diameter umbilical hoses are recognized to have significant drawbacks; for example, larger diameter hoses may have higher volumetric expansion with internal pressure than the smaller hoses that they replace, and umbilicals comprising large-diameter umbilical hoses may require large spools, large amounts of deck space and variable deck loading, and may be difficult to run and retrieve.

Another prior-art concept for reducing signal time has been to reduce the volumetric expansion of the control hoses. For example, the manufacturer of the industry-standard Synflex hydraulic hose (Eaton Corporation of Mantua, Ohio) has recently announced an “ultra-low volumetric expansion hose”, the model 3ULV-03, which the manufacturer claims “will provide signal response time that will enable drilling with hydraulic controls at 10,000 foot water depths.” However, the improvements in volumetric expansion are very limited, and the “improved” hose will be offered only in the industry-standard size of 3/16″ ID. Furthermore, as will be discussed in detail, the improvements in this hose are confined to total volumetric expansion; little or no improvement is observed in the differential volumetric expansion of the hose.

In a recent paper, “Well Intervention in Deep Waters” (OTC 19552 by Mathiassen, et al, presented at the 2008 Offshore Technology Conference, May 5-8, 2008) discusses upgrading a well intervention system from a conventional hydraulic control system to an electro-hydraulic system to allow operations in deeper waters. Inclusion of this paper is specifically not intended to be an admission that the paper is prior art, but instead reflects public information at the time of filing. The new electro-hydraulic system employs an all-electric umbilical and subsea hydraulic power units (HPUs) which convert the electric power supplied by the umbilical into hydraulic energy which is stored in a bank of accumulator bottles. As explained in the paper, “deeper depths often leads to larger diameter hoses in the [hydraulic] umbilical between the surface HPU and the subsea hardware to fend off the effects of fluid pressure loss and increased reaction time. But operational experience teaches us that a smaller umbilical is needed. Therefore the decision was made to go with an all-electric power umbilical, similar to what ROVs use today in their tether deployment systems, and subsea HPUs.”

In order to provide some of the benefits of a multiplex electric control system at a reduced cost, one prior-art BOP control system taught in U.S. Pat. No. 6,484,806 to Childers, et al, contemplates the conversion of an existing hydraulic control system to one in which selected critical functions are controlled by electrical lines or wires, while leaving the non-critical functions controlled by the hydraulic control system; that is, a hybrid hydraulic/electro-hydraulic BOP control system.

Defined as “critical functions” in this prior-art system are those BOP functions considered essential in containing a kick or blowout from the well during drilling operations. Functions satisfying this criteria will vary with the particular BOP equipment onboard, but typically include the shear ram BOP, multiple sets of pipe ram BOPs, and one or two annular type BOPs. Critical functions may also include at least one pair of choke and kill valves and/or the marine riser lower disconnection device depending upon operator preference. The use of electrical signaling techniques for critical functions can eliminate hydraulic signal delay altogether, with the result that the operation time of critical BOP functions can be reduced to actual fill-up time which is presently well within prescribed time limits regardless of water depth.

For the purposes of this disclosure, critical functions may also comprise the closing side of a subsea BOP control system, but in all cases critical functions will refer to a subset of all subsea control functions which are considered “critical” in a particular subsea application, particularly for reasons of safety.

Another system of the prior art is described in IADC/SPE Paper 19918 “Hydraulic BOP Controls for Deepwater Operation” (Stidston, et al) and “Installation, Operation, and Maintenance for Shaffer Pressure Bias System (Shaffer Manual P/N 69-00398)” from National Oilwell Varco of Houston, Tex. This system uses the industry standard 3/16″ inner diameter (ID) low volumetric expansion umbilical hoses, shear-seal type pilot-operated valves at the seabed (called “bias sequence valves”), and a low baseline pressure (which the authors call a “bias pressure”) maintained in the umbilical hose at all times to “essentially remove the volumetric expansion associated with hydraulic hose bundles.” Note that the shear-seal pilot-operated valves (“bias sequence valves”) also serve to vent the Sub-Plate Mounted (SPM) valves controlling fluid flow to the BOP actuators when they are not being actuated; for example, the opening side SPM valve is vented whenever the closing side SPM valve is actuated.

The maximum baseline pressure tested during development of this prior-art system was 600 psi, but in the commercially available system, described in the Shaffer Pressure Bias System manual, the nominal “bias pressure” is set at 100 psi, regulated to between 100-300 psi, and uses a 0-500 psi pressure gauge. The IADC/SPE paper teaches that “one of the interesting features of the test results was the relative unimportance of the bias pressure used, showing that the system was relatively insensitive [to bias pressure selection].”

Note that for the purposes of this disclosure, and contrary to the definitions used to describe the Shaffer system above, a “baseline pressure” is a static pressure maintained in a hydraulic control line, generally over and above the hydrostatic pressure, above which a control pressure signal is superimposed, and a “bias pressure” is a static reference pressure applied to a pressure-biased valve to provide a spring-like force.

Refer now to FIG. 1, a schematic of a prior-art subsea hydraulic control system with a baseline pressure, as taught in SPE/IADC paper 19918 (Stidston, et al). The system of FIG. 1 is divided into Surface Equipment 101A and Subsea Equipment 101B. The system is also divided into the Signal subsystem 110, Monitoring subsystem 114, and the Function subsystem 111. The system has separate “closing” and “opening” circuits, which are used to close and open a subsea BOP.

Hydraulic power at about 3000 psi from hydraulic pump 102 on the surface is supplied to the surface control valve 103 through surface piping 102A, to the baseline pressure regulation system 104 through surface piping 102B, and to the subsea accumulator system 102D through subsea hydraulic conduit 102C, to subsea manifold 102E. In some systems, subsea accumulator system 102D may also comprise a pressure regulator valve.

The baseline pressure regulation system 104 comprises a pressure regulator valve 104A, at least one pressure accumulator 104B, and a 0-500 psi pressure gauge 104C. Pressure within the baseline pressure manifold 105 is regulated to about 100 psi.

The signal subsystem 110 comprises surface control valve 103, spring-bias shuttle valves 106A and 106B, shuttle valve control lines 105A and 105B, umbilical hoses 107A and 107B, and pilot-operated opening valve 108A and pilot-operated closing valve 108B. Note that pilot operated valves 108A and 108B are also called “sequencing valves” or “bias sequence valves” in the prior art. Surface control valve 103 has open direction 103A and close direction 103B. Umbilical hoses 107A and 107B are conventionally located within an umbilical “bundle” attached to the drilling riser.

The function subsystem 111 comprises SPM open valve 109A, SPM close valve 109B, hydraulic piping 113A and 113B, and BOP actuator 112 which has open chamber 112A and close chamber 112B.

The monitoring subsystem comprises umbilical hose 115 hydraulically connected to subsea hydraulic manifold 102E, and pressure gauge 116 on the surface.

Pilot-operated open valve 108A is typically set at a 2100 psi actuation pressure, below which the valve will remain open and pressure in hydraulic piping 113A will be vented. Pilot-operated close valve 108B is typically set at a 900 psi actuation pressure, below which the valve will remain open and pressure in hydraulic piping 113B will be vented.

The surface control valve 103 is a three position, four-way hydraulic valve, which is shown as a manually-actuated valve, but which also typically may be actuated pneumatically or by other means known in the art.

When surface control valve 103 is in the neutral position (as shown), 100 psi baseline pressure from the baseline pressure regulator 104A is supplied through shuttle valve control line 105A and 105B to spring-bias shuttle valves 106A and 106B, to umbilical hoses 107A and 107B and thence to SPM open valve 109A and SPM close valve 109B. The preset opening pressures of SPM valves 109A and 109B (typically 2100 psi and 900 psi respectively) will prevent the 100 psi baseline pressure from opening either SPM valve. In the neutral position, the opening and closing chambers 112A and 112B are vented through SPM valves 109A and 109B respectively, and hydraulic piping 131A and 113B are vented through sequencing valves 108A and 108B.

Note, however, that the baseline pressure in umbilical hoses 107A and 107B may be reduced (for example, after the surface control valve is switched with high pressure in the umbilical hoses) only by bleeding-back through the baseline pressure regulator valve 104A on the surface, which may be a lengthy process and which may increase the signal time of subsequent operations.

When surface control valve 103 is actuated in the close direction 103B, hydraulic fluid at about 3000 psi from hydraulic pump 102 and pressure regulator system 104 is directed through shuttle valve control line 105B to spring-bias shuttle valve 106B, which switches to the left, shutting-off the baseline pressure and sending 3000 psi to sequencing valve 108B, which opens, sending 3000 psi pressure to SPM valve 109B, which opens at about 900 psi, causing pressurized fluid from subsea manifold 102E to enter close chamber 112B, closing the subsea actuator 112.

Pressure gauge 116 monitors the pressure in subsea manifold 102E. When SPM valve 109B opens, the pressure in subsea manifold 102E will drop, which will be indicated, after some delay, on pressure gauge 116. When subsea actuator 112 is fully closed, the pressure in subsea manifold will rise to its nominal level, which also will be indicated on pressure gauge 116 after some delay. When the pressure indicated has returned to the nominal level for subsea manifold 102E, it is considered verification that subsea actuator 112 is fully closed. In deep water, the delay between a change in pressure in the subsea manifold 102E and indication of that pressure change on pressure gauge 116 may be about 15-20 seconds, which is a high percentage of the allowable closing time for a ram or annular BOP.

When surface control valve 103 is subsequently actuated in open direction 103A, shuttle valve control line 105B is evacuated, which ultimately evacuates close chamber 112B. Simultaneously, 3000 psi hydraulic pressure is applied to spring-bias shuttle valve 106A, and thence to opening chamber 112A.

It is also taught in the prior art that shear-seal type valves are required in deepwater hydraulic control systems for their longevity and clean valving action, For example, shear-seal type valves have been extensively taught as the preferred valve-sealing method for subsea control systems of all types, including hydraulic systems, electro-hydraulic systems, and MUX systems, and including hydraulically-actuated valves (both spring- and pressure-biased) as well as electrically-operated solenoid valves. These include, for example, U.S. Pat. No. 3,460,614 to Burgess, U.S. Pat. No. 3,993,100 to Pollard, et al, U.S. Pat. No. 4,497,369 to Hurta, et al, U.S. Pat. No. 5,042,530 to Good, et al, U.S. Pat. No. 6,032,742 to Tomlin, et al, U.S. Pat. No. 6,814,104 to Dean, and U.S. Pat. No. 7,000,890 to Bell, et al. However, the use of shear-seal type valves has been taught without regard to the volume of fluid required to actuate the valve, or the Flow Coefficient across the valve.

The pilot-operated valves used in prior-art hydraulic control systems require relatively large volumes of hydraulic fluid to actuate (typically on the order of over 25-100 cubic centimeters, but commonly over 50 ccs.) and have very low flow coefficients (Cv). While the flow coefficient (Cv) of a pilot valve in a subsea control system will obviously not affect the signal time of the system, it may increase the response time by restricting flow to the SPM valves. For this reason it is always highly desirable that the pilot-operated valve have a high flow coefficient.

Prior-art hydraulic control systems typically use only shear-seal pilot-operated valves because they are robust and dependable. However, because shear-seal valves develop high frictional loads between the sealing surfaces, they typically have low Cv (in order to reduce the shear area and consequently the seal friction) and large actuation areas (to increase the actuation force to reliably overcome the seal friction). In addition, because the shear seal is, by definition, at a right angle to the actuation axis, the actuation distance of a shear-seal valve (typically, roughly equal to the overall diameter of the shear seal) tends also to be large. The product of a large actuation area and a large actuation distance is a large actuation volume; consequently, practical shear-seal valves typically have actuation volumes which may be very large relative to the Cv of the valve.

FIG. 3 shows a spring-biased shear-seal valve from Gilmore Valves of Houston, Tex., which is typical of the valves used in prior-art subsea hydraulic control systems. This valve weighs about 4½ pounds, and has an actuation volume (the volume of hydraulic fluid required to actuate the valve) of approximately 50 cubic centimeters, and a Cv of 0.02. The ratio between the actuation volume (in cubic centimeters) and the Cv for this particular valve is approximately 2500.

Referring still to FIG. 3, the shear-seal valve comprises a valve body 300, a shear-seal bobbin 301, bobbin seal 301A, shear seal spools 302A and 302B, a bias spring 303, a shear-seal cartridge 304, and three hydraulic ports: a pilot pressure port 305, a function port 306, and a vent port 307. The actuation area of the valve is defined by the area of the bobbin seal 301A.

Hydraulic control system umbilical hoses typically have had zero baseline internal pressures (that is, the internal pressure in the hose, over and above hydrostatic pressure, in a normal static condition with no signal pressure applied to it). In one instance in the prior art, it is taught that a nominal baseline pressure of 100 psi “removes the volumetric expansion associated with hydraulic hose bundles.” For example, prior-art hydraulic subsea BOP control systems today may comprise umbilical hoses from the surface to proximate the seabed that are 3/16″ ID or larger, with zero baseline pressure (but in no known case greater than 100 psi nominal), hydraulically connected to spring-biased shear-seal pilot-operated valves with relatively large actuation volumes and Cv values typically significantly below 0.5. These all-hydraulic control systems of the prior art are typically not used at all in “ultra deep” water, that is, at water depths greater than about 5,000 feet, as they may not achieve the required response time at those water depths. Instead, they are today commonly replaced with MUX control systems for deepwater drilling.

Consequently, there remains a need for an improved hydraulic BOP control system that can be used in deep water without the slow signal and monitoring times of prior-art all-hydraulic systems or the high cost, complexity, and unreliability of electro-hydraulic or even hybrid hydraulic/electro-hydraulic systems.

It would also be desirable if such an improved hydraulic BOP control system could be retrofitted to existing hydraulic control systems with minimal equipment modifications and installation onboard the drilling rig. Further, it would be desirable if the subsea portion of the control system were easily retrievable by a Remotely Operated Vehicle (ROV), and if the improved hydraulic control system could be adapted for use with many different types of subsea equipment, such as production manifolds, pipeline valves, and production trees.

### BRIEF SUMMARY OF THE INVENTION

The present invention comprises a hydraulic control system and method for rapidly actuating subsea equipment in deep water comprising a combination of a subsea control valve having a small actuation volume with a small internal diameter umbilical hose extending downward to the control valve.

Unlike prior art hydraulic systems which relied on significant flow volumes (on the order of 25-100 cubic centimeters or more, the present invention relies on a smaller fluid flow (preferably about 2 cubic centimeters or less) associated with a hydraulic pressure pulse to actuate the small volume actuation control valve. As a result, the present invention significantly reduce the signal time of a deepwater hydraulic control system, and therefore the response time, in a hydraulic control system which is contrary to the teachings of the prior art.

Preferably, the present invention may comprise small diameter control umbilical hoses, at a relatively high baseline pressure, and pilot-operated valves with very low actuation volumes. Preferably, particularly a hydraulic control system for reducing the signal time to a subsea blowout preventer (BOP) in water depths up to and greater than about 5000 feet.

Preferred embodiments of the present invention comprises a valve arrangement which hydraulically actuates one side of a hydraulic control function, while simultaneously evacuating the opposing circuit both at the seabed and at the surface. Preferably the control valve is a pilot-operated valves of the shuttle-type valves design. Preferably, the pilot-operated valves have at least one axial metal-to-metal seal. Preferably, the pilot-operated valve utilized in the preferred embodiment of this invention have an actuation volume of less than 2 cubic centimeters (ccs), are pressure-biased at a ratio of 3:1 or less, and/or have a ratio of Actuation Volume to Flow Coefficient (Cv) of less than 2.

In preferred embodiments of the present invention, the Baseline Pressure is greater than 100 psi, and may be greater than 600 psi or even greater than 1000 psi. Preferably, Baseline Pressure in the hydraulic control system of the present invention is selected such that the differential volumetric expansion of the umbilical hose at the Baseline Pressure is less than 1×10⁻⁴ ccs per foot of hose per psi of signal pressure, or more preferably, less than 5×10⁻⁵ ccs per foot of hose per psi of signal pressure.

In preferred embodiments, the umbilical hose may be preferentially located proximate the center of an umbilical bundle in order to minimize volumetric expansion. Preferably, the umbilical hose has a plurality of layers of reinforcing fibers the elastic moduli of which increase with the diameter of the reinforcement layer. In other embodiments, the umbilical hose has a plurality of spirally-wound reinforcing fibers.

In preferred embodiments, the hydraulic fluid may be selected for a high acoustic velocity, preferably greater than the acoustic velocity of seawater. In some preferred embodiments, the selected hydraulic fluid may be water-based.

As can be seen, the present invention offers benefits including, but not limited to, quicker signal and response times in deepwater, smaller umbilical size and weight, reduced hydraulic fluid volumes, lower control pod size and weight, and, an overall cost (including initial cost, maintenance cost, and cost of downtime) which may be lower than prior art hydraulic control systems, multiplexed electric/hydraulic control systems, or hybrid electro-hydraulic/hydraulic control systems.

### BRIEF DESCRIPTION OF THE SEVERAL VIEWS OF THE DRAWINGS

FIG. 1 is a schematic of a prior-art subsea hydraulic control system with a baseline pressure.

FIG. 2A is a graph of the volumetric expansion versus internal pressure of “Synflex” 38LV (Low Volumetric expansion) hose from Eaton Corporation, Mantua, Ohio.

FIG. 2B is a graph of the volumetric expansion versus internal pressure of a prior-art low volumetric expansion hose taught in U.S. Pat. No. 6,531,742.

FIG. 2C is a representative graph of volumetric expansion versus internal pressure for a hose as used in the current invention.

FIG. 3 shows a spring-biased, shear-seal, pilot-operated valve of the prior art.

FIG. 4A shows a pressure-biased axial-seal pilot-operated shuttle valve as used in the current invention, in the closed position.

FIG. 4B shows a pressure-biased axial-seal pilot-operated shuttle valve as used in the current invention, in the open position.

FIG. 5 shows a hydraulic schematic of an embodiment of the current invention with baseline pressure applied to the both the closing and opening sides of a deepwater hydraulic control system.

FIG. 6 shows a hydraulic schematic of an embodiment of the current invention with baseline pressure applied to the closing side of a deepwater hydraulic control system.

FIG. 7 shows a hydraulic schematic of a monitoring subsystem of an embodiment of the current invention with a bias pressure applied to a pressure monitoring subsystem.

### DETAILED DESCRIPTION OF THE PREFERRED EMBODIMENT

The present invention primarily concerns the Signal subsystem of a subsea hydraulic control system, that is, a subsystem for providing a hydraulic pilot signal to the Actuation subsystem. The present invention comprises a hydraulic control system and method for rapidly actuating subsea equipment in deep water comprising a combination of a subsea control valve having a small actuation volume with a small internal diameter umbilical hose extending downward to the control valve.

The presence of an Actuation subsystem of a type known in the art, with adequate hydraulic capacity to actuate subsea equipment within times currently known in the art, is assumed in this description. An effective Actuation subsystem will typically comprise a large number of accumulator bottles, but it may also comprise a subsea hydraulic power source, such as an electrically-powered subsea HPU. Alternatively, it may comprise a means of pressurizing the hydraulic fluid in response to the hydrostatic head of the seawater, as taught, for example, in U.S. Pat. No. 6,192,680 (to Brugman, et al).

### Hydraulic Versus Electro-Hydraulic Signal Times

Since hydraulic and electro-hydraulic subsea control systems generally have similar (if not identical) Actuation subsystems, the difference in response times between hydraulic systems and electro-hydraulic systems (including MUX systems) operating in deep water is typically due to the different signal times of each system at a particular water depth; that is, the time required for the Signal subsystem to provide a hydraulic signal to operate the Function subsystem.

In the case of electro-hydraulic systems, the electrical signal will travel at roughly the speed of light, so that the response time of the system will largely be governed by the speed of the solenoid and the Flow Coefficient of the solenoid-operated valve; for the MUX variant of the electro-hydraulic system, signal time will also comprise a time for the digital signal to be “decoded” within the control pod.

By contrast, the signal time for a hydraulic control system is limited by the theoretical maximum speed of the signal through the hydraulic fluid, which is the speed of sound in the hydraulic fluid (also called “acoustic velocity” to distinguish it from the speed of sound in air). Acoustic velocity in the water-based hydraulic fluids used in subsea systems is generally on the order of 5,000 feet per second, that is, comparable to the acoustic velocity in sea water.

For subsea control of equipment at water depths of around 10,000 feet, the roughly two-second difference between the speed of light governing electro-hydraulic systems and the acoustic velocity in hydraulic fluid governing hydraulic systems would not, by itself, increase the response time of a hydraulic control system very significantly.

In prior art hydraulic systems, however, the practical speed of the hydraulic signal falls-off significantly below the optimum (and the signal time gets very long) with increasing water depth due to a combination of factors, including but not limited to pilot-operated valves with high actuation volumes and low Flow Coefficients (Cv), and hoses with low flow coefficients and high volumetric expansion. Typically, prior art hydraulic control systems rely on relatively significant flow volumes (on the order of 25-100 ccs or more) to function.

By contrast, the hydraulic control system of the present invention relies on a very small fluid flow (preferably about 2 cubic centimeters or less) associated with a hydraulic pressure pulse to actuate a low actuation-volume pilot-operated valve. One goal of the present invention is for the hydraulic signal to approach the “large tank” acoustic velocity in the hydraulic fluid employed.

### Acoustic Velocity in Liquids

In very rigid pipe, or in a large tank (or, for example, a body of water), the speed of sound in a fluid follows the relationship

a=C(√K/ρ) (Equation 1)

where

a=acoustic velocity in a liquid, feet per second (meters per second)

C=a constant, 8.615 for Imperial units (1.0 for SI units)

K=isentropic bulk modulus of the fluid, psi (kPa)

ρ=specific gravity.

The bulk modulus of a fluid is a measure of its incompressibility; the higher the bulk modulus, the more incompressible the fluid. A fluid with a relatively high acoustic velocity, then, will have relatively low density, but be relatively incompressible.

In some embodiments of the present invention, a hydraulic fluid with a high acoustic velocity is advantageously selected. For example, at room temperature the acoustic velocity in seawater is about 5000 feet per second, but is approximately 5500 feet per second for glycerine. Note, however, that hydraulic fluid manufacturers typically do not test or report the acoustic velocity of their fluids, so some reasonable amount of experimentation on various candidate fluids may be required to determine which hydraulic fluid will give optimum performance in a hydraulic control system of the present invention.

In particular, some prior-art water-based hydraulic control fluids include glycol antifreeze additives for use in cold climates; these glycol additives are believed to significantly alter the acoustic velocity of the mixed fluid, particularly when mixed near the eutectic ratio (typically about 40% glycol).

### Acoustic Velocity in Rigid Pipes

In liquid piping systems, it is well known in the art that acoustic velocity can be significantly affected by pipe wall radial compliance; for nominally rigid piping, the acoustic velocity equation (Equation 1, above) can be adjusted to account for pipe compliance as follows:

adjusted=[C(√K/ρ)]/[√(1+(D/t×K/E))] (Equation 2)

where

adjusted=acoustic velocity in a liquid, adjusted for pipe compliance, fps (mps)

C=a constant, 8.615 for Imperial units (1.0 for SI units)

K=isentropic bulk modulus of the fluid, psi (kPa)

ρ=specific gravity

D=pipe diameter, in (mm)

t=pipe wall thickness, in (mm)

E=elastic modulus of the pipe material, psi (kPa).

That is, a pipe with a higher ratio of pipe diameter to wall thickness (D/t) will be more radially compliant (that is, deform radially more under internal pressure) than a smaller diameter pipe with the same wall thickness. In addition, a pipe material with a higher elastic modulus will also be less compliant.

In hydraulic piping and hoses for subsea control systems, radial compliance is expressed as “volumetric expansion”, usually in the mixed units of cubic centimeters of additional volume, per foot of hose, at a particular change in internal pressure.

In the prior art, volumetric expansion usually means the total volumetric expansion from zero to some internal pressure. For the purposes of the present invention, which comprises a baseline internal pressure, a key concept is differential volumetric expansion, which means the volumetric expansion per psi pressure increase, per foot of hose, at a particular baseline pressure. The total differential volumetric expansion means the volumetric expansion, per foot of hose, between a baseline pressure and a signal pressure which will actuate a pilot-operated valve. For example, as discussed below, the total volumetric expansion of a hose between zero psi and 500 psi will typically be much larger than the total differential volumetric expansion between a baseline pressure of 1000 psi and a signal pressure of 1500 psi.

### Acoustic Velocity in Hoses

Equation 2 does not apply directly to high pressure hoses because hoses have composite construction, and therefore do not have one singular elastic (or Young's) modulus, as would a monolithic, isotropic piping material such as steel.

High-pressure, low volumetric expansion umbilical hoses used in the present invention will typically comprise a thermoplastic liner, spirally over-wrapped and/or braided fiber reinforcement (sometimes comprising aramid fibers such as Kevlar®), and a polymer sheathing.

As composite hoses are anisotropic, they will typically have a separate elastic modulus for each principal direction (axial, radial and hoop). These moduli will typically be non-linear, and will depend on the current stress state in the hose. For the purposes of understanding volumetric expansion of hose used in the present invention, the predominant principal direction is the hoop direction.

At low internal pressure, it has been observed that the elastic modulus in the hoop direction is quite low (that is, the change in hose diameter per unit of internal pressure is quite high); it is believed that this is because at low pressures, the thermoplastic liner is being initially compressed, but the fiber reinforcements are not yet fully loaded. As the internal pressure gets higher, it has been observed that the elastic modulus in the hoop direction gradually gets larger as successive layers of reinforcing fibers are loaded. In other words, the elastic modulus of umbilical hose in the hoop direction is a non-linear function of the internal pressure in the hose.

This variable elastic hoop modulus explains the “volumetric expansion” behavior observed in the umbilical hoses which comprise the hydraulic conduit in hydraulic control systems; for example, the industry-standard Synflex 38LV-03 low volumetric expansion 3/16″ ID hose (available from Eaton Corporation of Mantua, Ohio), has a thermoplastic liner with two layers of spirally-wrapped fiber reinforcement and an extruded thermoplastic hose cover. It has been observed during pressure testing that this hose “stiffens-up” during loading (that is, expands less per unit increase in pressure) in a manner consistent with a gradually increasing elastic hoop modulus.

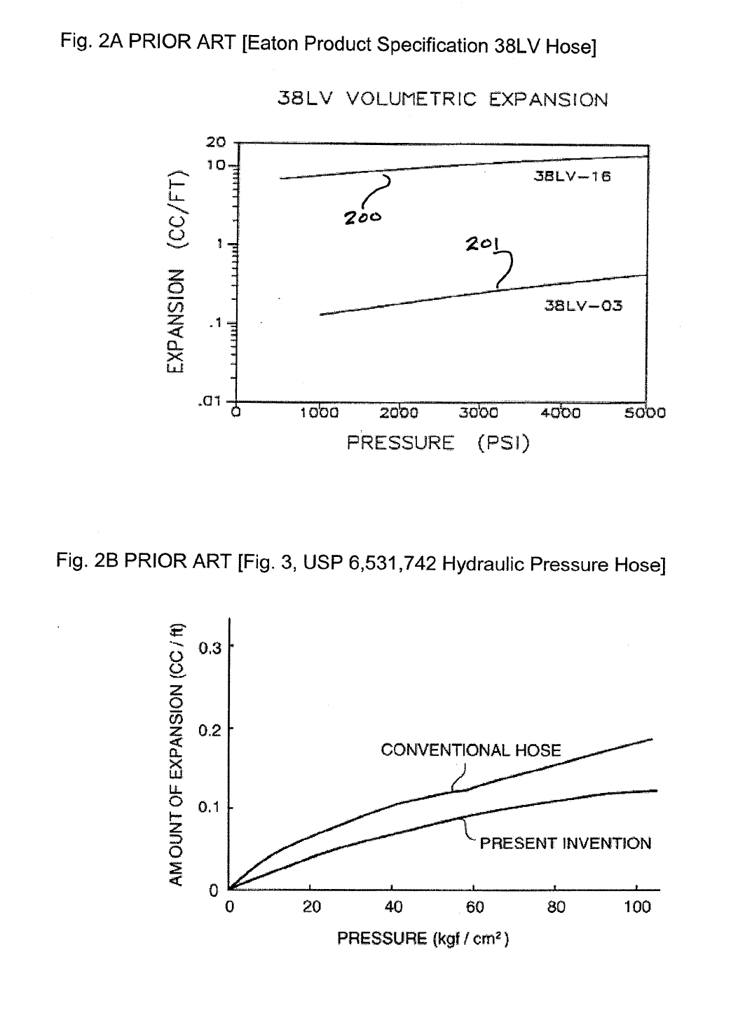

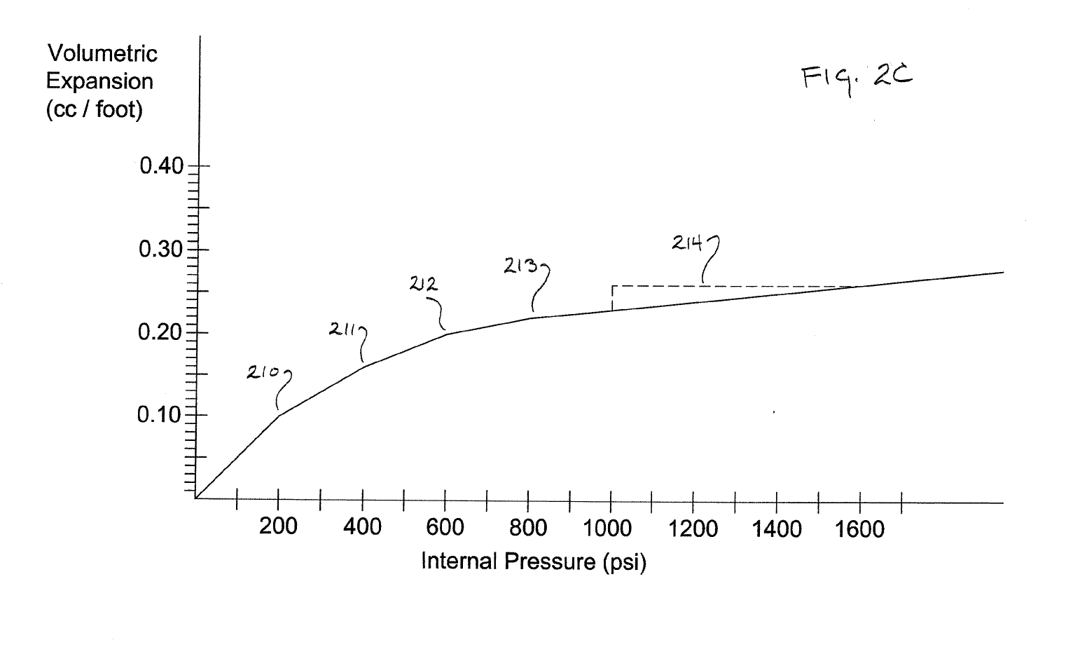

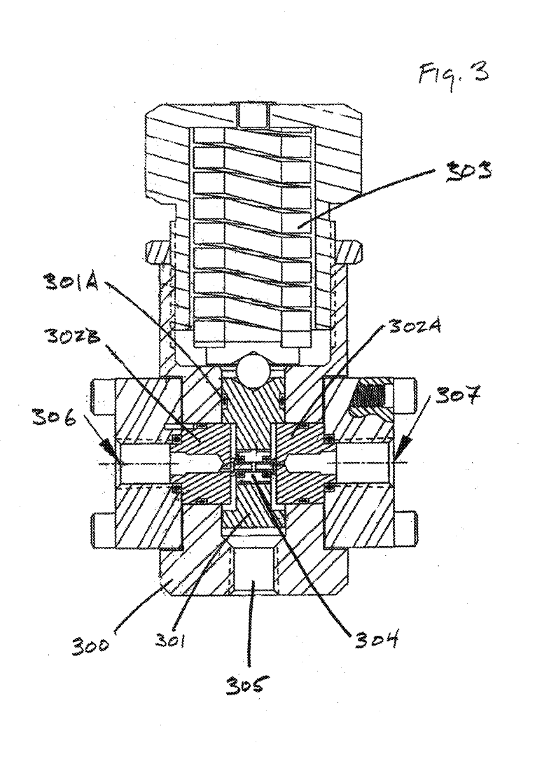

Refer now to FIG. 2A, which shows the volumetric expansion versus internal pressure of the industry-standard family of umbilical hose, Eaton “Synflex” 38LV. Curve 200 represents 1″ ID hose (38LV-16), and curve 201 represents 3/16″ ID hose (38LV-03). The 3/16″ ID hose is further described in U.S. Pat. No. 4,898,212 granted to Searfoss, et al (the -212 patent).

As shown in curve 101, 3/16″ 38LV-03 hose has a volumetric expansion of more than 0.2 cubic centimeters per foot of hose between zero psi and 3000 psi, the typical operating conditions for most prior-art hydraulic subsea control systems. Thus the internal volume of 10,000 feet of 38LV-03 hose will increase by more than 2 liters (2000 cc) under typical control system operating conditions. In practical terms, this means that the 38LV-03 hose must be filled with about 2 liters of fluid at pressure before a significant amount of fluid can be delivered at pressure at the subsea end of the hose. The speed at which this hose will expand over its entire length will naturally be governed by the Cv of the hose, which is typically quite small. The net result, as seen in testing by the inventors and others, is that only 5000 feet of industry standard 3/16″ Synflex 38LV-03 hose may take over 20 seconds to reach 3000 psi at the distal end.

FIG. 2B shows a similar graph for a prior-art hydraulic brake hose with braided reinforcement, as taught in U.S. Pat. No. 6,631,742 (the -742 patent). Note that the volumetric expansion scale in FIG. 2 is linear rather than logarithmic, so that it is easier to see the “flattening” of the volumetric expansion curve at higher pressures, that is, the volumetric expansion of the hose per unit of increased pressure generally becomes smaller at higher pressures, which is consistent with an increasing elastic hoop modulus.

The relationship between the observed volumetric expansion of hose and the “elastic hoop modulus” can be approximated as follows:

σ_{HOOP}=pD/2t (Equation 3A)

and

ε_{HOOP}=σ_{HOOP}/E_{HOOP} (Equation 3B)

therefore

ε_{HOOP}=pD/2E_{HOOP}t (Equation 3C)

where

σ_{HOOP}=hoop stress, psi (kPa)

ε_{HOOP}=hoop strain, psi (kPa)

p=internal pressure, psi (kPa)

D=pipe ID, inches (mm)

t=pipe wall thickness, inches (mm)

E_{HOOP}=elastic hoop modulus, psi (kPa)

where E=f(p).

One implication of the relationship shown in equations 3A-3C is that a hose with a smaller ratio of diameter (D) to wall thickness (t) will strain less in the hoop direction (that is, expand less). For this reason, the umbilical hose of the present invention will preferably have an inner diameter less than the industry-standard 3/16″ in order to minimize the D/t ratio of the hose and therefore reduce its volumetric expansion.

Another implication of the relationship shown in equations 3A-3C is that the design of the preferred umbilical hose preferably has its highest elastic hoop modulus (and the lowest differential volumetric expansion) at or near the baseline pressure. This in turn also implies that an umbilical hose used with the present invention may be relatively compliant at low internal pressures, but preferably should “stiffen-up” in hoop at or near the baseline pressure.

In one preferred embodiment of the present invention, for example, the umbilical hose has one or more spirally-wrapped outermost layers of a high-modulus reinforcing fiber (such as an aramid fiber, a carbon fiber, a boron fiber, or a basaltic glass fiber) separated from the inner layers of fiber reinforcement by a compliant layer such as an elastomer. The one or more outermost fiber layers may, for example, have a high wind angle (that is, close to 90 degrees to the longitudinal axis of the hose), and a relatively low fiber twist (that is, less than 1.5 turns per inch). Using this construction, the relatively stiff outermost fibers will not “load” until the complaint layer has fully compressed, which will be a function of the modulus of the complaint layer and the layers underneath it.

The rise in hoop stiffness of the hose near the baseline pressure may be tailored, for example, by changing the modulus and thickness of the outermost fiber layer and the complaint layer, by changing the ratio of two or more constituent fibers in the outermost fiber layer, by changing the twist of the reinforcing fibers, as well as by changing the wind angle of the outermost fiber layer.

Refer to FIG. 2C, a representative Volumetric Expansion curve for an umbilical hose of the present invention which demonstrates the advantages of a high baseline pressure. The curve of FIG. 2C has inflection points 210, 211, 212, and 213 which represent the onset of hoop loading of subsequent layers of hose reinforcement; inflection point 210 may represent the hoop loading of a first layer of fiber reinforcement, inflection point 211 may represent the hoop loading of a second layer, as so forth. Note that the sharpness of the inflection points is exaggerated for clarity.

As each layer of reinforcement is loaded in the hoop direction, the differential volumetric expansion (represented by the slope of the curve) generally tends to get smaller. Slope 214 represents the total differential volumetric expansion between 1000 psi and 1600 psi; the total differential volumetric expansion within this interval is 0.02 cc/foot over a pressure differential of 600 psi, or about 0.0033 cc/foot of hose/100 psi change in internal pressure, or 0.33×10⁻⁴ cc/foot of hose/psi change in internal pressure.

For example, a system of the present invention operating at about a 1000 psi baseline pressure, with a 1200 psi pilot-operated valve opening pressure, and about a 10,000 foot umbilical hose length, the total differential volumetric expansion of the hose represented in FIG. 2C due to the signal pressure would be about 66 cubic centimeters. Naturally, the preferred umbilical hose of the present invention may have a larger or smaller differential volumetric expansion without departing from the teachings of this disclosure.

It is believed that high angle spiral reinforcement of the hose (greater than about 75 degrees from the longitudinal axis of the hose) is preferred over braided reinforcement for improved fatigue life, less movement of the reinforcing fibers under internal pressure, and consequently, a flatter volumetric expansion curve at or near a selected baseline pressure.

It is also believed that the volumetric expansion behavior of the umbilical hose of the present invention may also be optimized in other ways, including, for example, employing a “modulus gradient” wherein the modulus of the reinforcing fibers gets progressively higher in the reinforcing layers towards the outside of the hose, or, in cases where the reinforcing layers are comprised of a composite of fibers of differing tensile modulus (as taught, for example, in the '212 patent for the purpose of extending fatigue life), using a progressively higher percentage of high-modulus fibers in the outermost reinforcing layers. In keeping with the present invention, these strategies may be used to tailor the characteristics of the hose such that the differential volumetric expansion is minimized at or near the baseline pressure.

### Shuttle-Type Pilot-Operated Valve

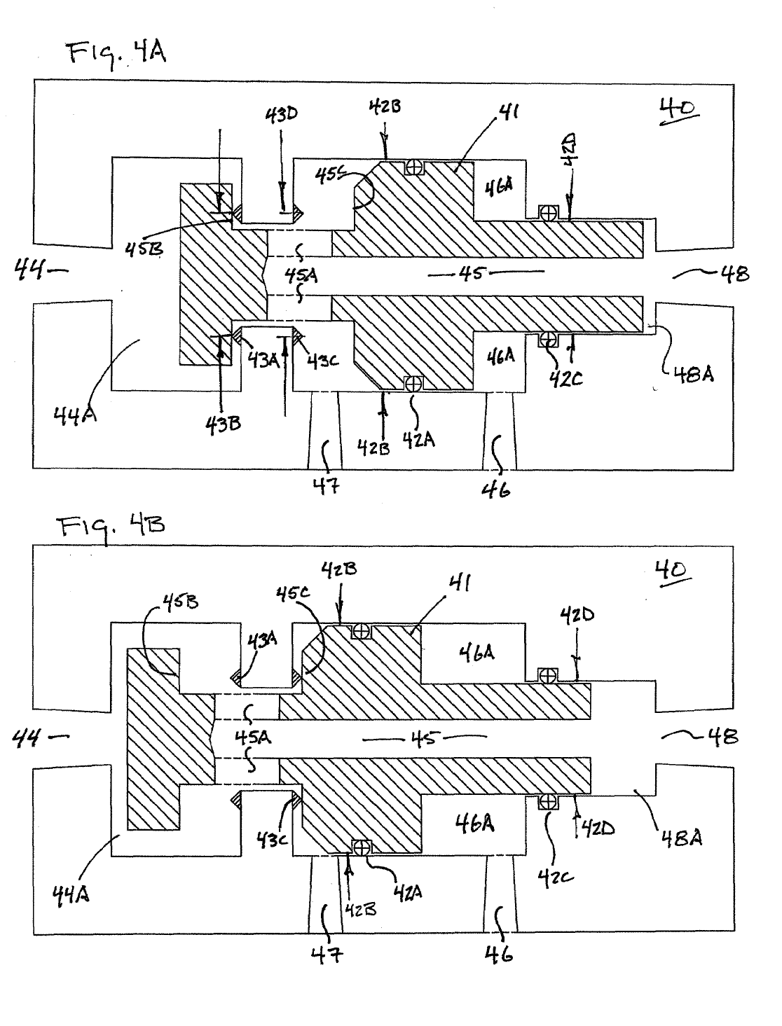

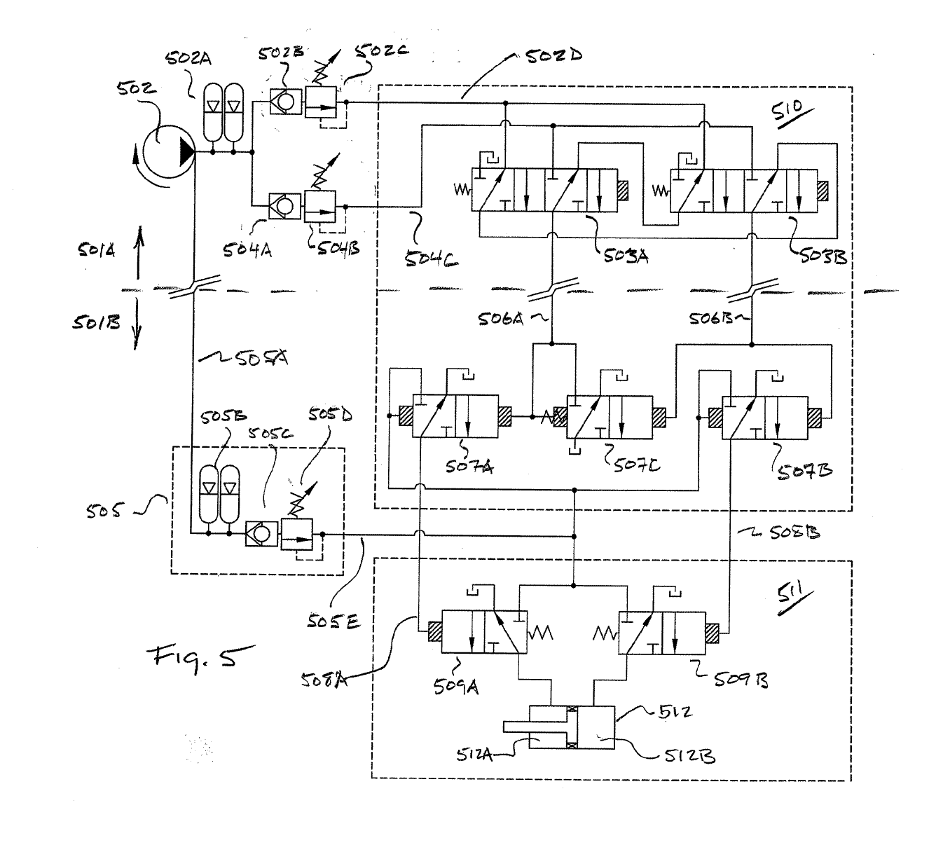

FIG. 4A shows a preferred valve for the present invention, a shuttle-type pressure-biased pilot-operated control valve which may be employed in the closed position. Valves designs suitable for the present invention can be modified from valves available from ABCO Valves of Houston, Tex. in accordance with the present disclosure.

In this embodiment, the control valve comprises a generally cylindrical valve body 40 with a bobbin 41 disposed inside. Body 40 has pressure port 44, pilot port 46, vent port 47 and discharge port 48. Body also has axial primary seal 43A and axial secondary seal 43C, which have seal diameters 43B and 43D respectively. Bobbin 41 has primary seal shoulder 45B which seals against axial primary seal 43A, and secondary shoulder 45C which seals against axial secondary seal 43C.

Axial primary seal 43A will preferentially be a metal-to-metal seal to insure a minimal axial displacement of the bobbin 41 before the valve opens. Axial secondary seal 43C may also be a metal-to-metal seal, but in some embodiments may alternately be an elastomeric seal to cushion the impact with the secondary sealing shoulder 45C when the valve snaps open.

Pressure port 44 is connected to a subsea source of hydraulic pressure; conventionally, this source consists of charged accumulator bottles, but other sources known in the art, such as an electrically-powered subsea Hydraulic Power Unit (HPU), for example, may be used. Typically, this pressure source will be pressure regulated by means known in the art to about 3000 psi.

Pilot port 46 is hydraulically connected to the control umbilical hose to the surface.

The axial position of the bobbin 41 is maintained in the closed position by the subsea pressure source acting on metal-to-metal seal area defined by metal-to-metal seal area 43B in opposition to the pilot pressure in

Vent port 47 is hydraulically connected to a volume of relative low pressure; in some embodiments of the present invention, vent port 47 will dump to the sea, but in other embodiments it may be connected hydraulically, for example, to a pressure-compensated reservoir tank for a subsea HPU.

Discharge port 48 will typically be hydraulically connected to a pilot-operated function control valve which actuates the subsea equipment, for example, an SPM valve.

Bobbin 41 has axial passage 45 with cross-drilled vents 45A. Typically, the cross-sectional areas of passage 45 and vents 45A will largely determine the Flow Coefficient (Cv) of the valve. In one embodiment of the present invention, the pilot-operated valve will have a Cv equal to or greater than 1.0.

Circumferential elastomeric seals 42A and 42C are disposed between the valve body 40 and bobbin 41, and hydraulically define pilot chamber 46A. Seals have seal diameters 42B and 42D respectively.

With bobbin 41 in the closed position, as shown in FIG. 4A, pressure port 44 is sealed-off from the rest of the valve by an axial metal-to-metal seal 43A between the bobbin shoulder 45B on bobbin 41 and the body 40. Those skilled in the art will recognize that metal-to-metal seal 43A may be implemented in a number of ways known in the art, but that it is preferably an interference seal (as opposed to, for example, a pressure-energized metal-to-metal seal), and that it will typically have a seal angle between 12 and 18 degrees.

The movement of the shuttle 41 between the closed position shown in FIG. 4A and the open position shown in FIG. 4B is determined by a balance between a closing force and an opening force. The closing force is provided by a regulated bias pressure at pressure port 44 acting on the area of metal-to-metal seal 43A as defined by seal diameter 43B (the “closing area”), and the opening force is provided by a signal pressure at pilot port 46 acting on the area defined by the difference between seal diameters 42B and 42D (the “opening area”).

Preferably, the opening area is less than or equal to three times the closing area. More preferably, the opening area is less than or equal to two times the closing area. In an embodiment with an opening area which is two times the closing area, the valve may have a regulated bias pressure of 3000 psi, and a baseline pressure of about 1250 psi, and will open when the signal pressure reaches about 1500 psi.

While the valve shown in FIGS. 4A and 4B are pressure biased, those of ordinary skill in the art will recognize that one or more bias springs (not shown) may be easily added to a valve of this type; for example, Bellville springs (or similar devices) may be added to pressure port chamber 44A to bias the valve towards the closed position shown in FIG. 4A. Alternately, a Belleville spring or similar may be added to discharge port chamber 48A to bias the valve towards the open position shown in FIG. 4B.

### Hydraulic Actuation Volume

For the purposes of this disclosure, the Hydraulic Actuation Volume of a control valve is defined as the volume of hydraulic fluid required to open the control valve, independent of the pressure required. The Hydraulic Actuation Volume of the valve shown in FIGS. 4A and 4B is nominally equal to the difference in the areas defined by seal diameters 42B and 42D, times the length of the axial movement of the bobbin 41 which is required to unseat metal-to-metal seal 43A.

For the preferred embodiments of the present invention, a valve equipped with axial metal-to-metal seals will be utilized. This type valve typically has the lowest possible Hydraulic Actuation Volume, as the axial movement required to unseat the seal is less than that of a resilient seal (for example, an elastomeric face seal) which generally must decompress before unseating, and significantly lower than the distance required to unseat a shear-seal valve. Careful tuning of the balancing forces in the valve (whether hydraulic or spring forces) allows the Hydraulic Actuation Volume to be reduced significantly. For example, in a pressure-biased valve as shown in FIGS. 4A and 4B, if the seal area defined by metal-to-metal seal 43A is made relatively small, then the difference in the seal areas defined by seal diameters 42B and 42D can be made smaller, which, by definition, will reduce the Hydraulic Actuation Volume. In the preferred embodiments of the current invention, pilot-operated valves will have Hydraulic Actuation Volumes less than 10 cubic centimeters, more preferably, less than 2 cubic centimeters.

For the purposes of this disclosure, the ratio of Hydraulic Actuation Volume to Cv is defined as the ratio of the Hydraulic Actuation Volume in cubic centimeters to the throughput Cv of the valve in the open position (as in FIG. 4B for example) in gallons per minute of water flow at 60 degrees F., with a pressure drop of 1 psi). Preferably, the pilot-operated valve will have a ratio of Hydraulic Actuation Volume (in cubic centimeters) to flow coefficient (Cv) less than 100; more preferably less than 2. For example, a preferred embodiment of the present invention, the pilot-operated valve will have a Hydraulic Actuation Volume less than or equal to 2 ccs, and a Cv greater than or equal to 1.0.

### Exemplary Hydraulic Circuits

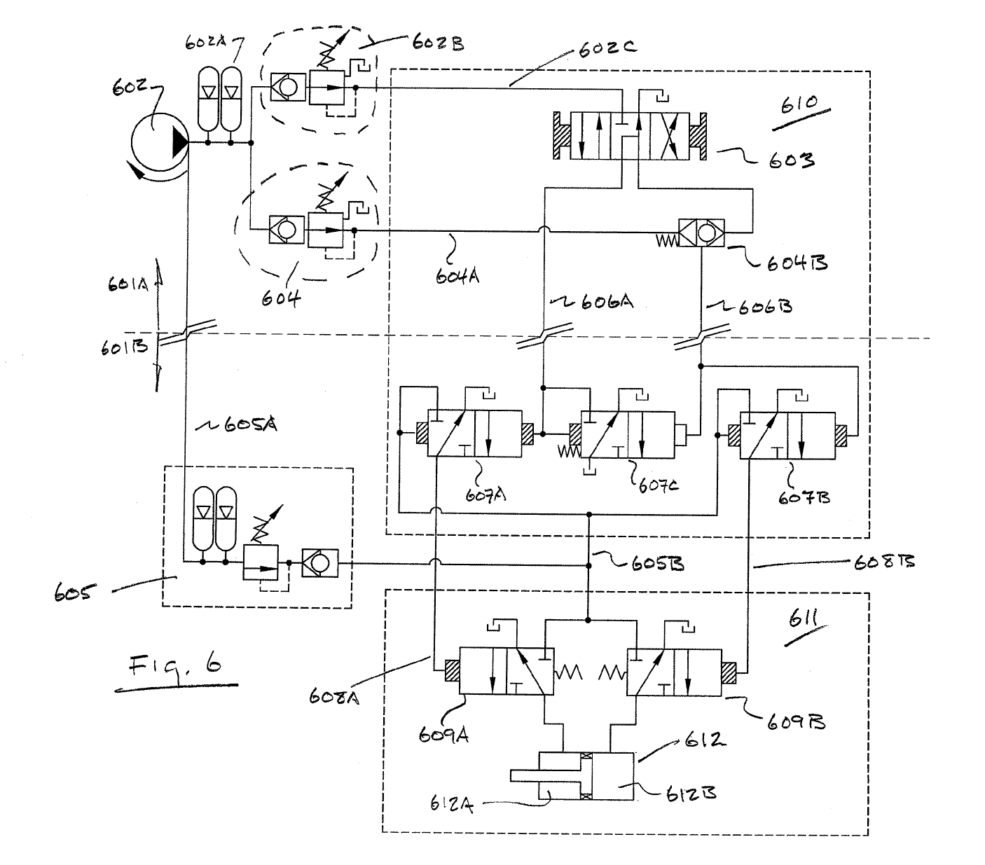

Refer now to FIG. 5, a schematic of a deepwater subsea hydraulic control system representing a preferred embodiment of the present invention. The system of FIG. 5 is divided into Surface Equipment 501A and Subsea Equipment 501B. The system is also divided into the Signal subsystem 510 and the Function subsystem 511. The system has separate “closing” and “opening” circuits, which are used to close and open a subsea BOP (not depicted).

In the preferred embodiment, hydraulic pressure at about 3000 psi is supplied to the “opening” surface control valve 503A and the “closing” surface control valve 503B from hydraulic pump 502 by way of accumulators 502A, check valve 504A, pressure regulator 504B, and surface piping 504C. Typically, pressure regulator 504A will be set at or very near to 3000 psi.

Hydraulic pressure of about 3000 psi is also supplied to subsea accumulator system 505 from through subsea conduit 505A, subsea accumulators 505B, check valve 505C, subsea regulator 505D, and subsea pressure piping 505E. Subsea conduit 505A is typically a one inch ID jointed rigid pipe attached to the drilling riser, but it also may be a flexible hose within the BOP control umbilical, or other conduit means known in the art.

In similar fashion, a baseline hydraulic pressure preferably greater than 100 psi, but typically between about 600 and about 1500 psi, is provided to the surface control valves 503A and 503B from hydraulic pump 502 by way of accumulators 502A, baseline check valve 502B, baseline pressure regulator 502C and baseline pressure piping 502D.

Signal subsystem 510 comprises surface control valves 503A and 503B, opening umbilical hose 506A, closing umbilical hose 506B, and subsea pilot-operated valves 507A, 507B, and 507C.

In the preferred embodiment, umbilical hoses 506A and 506B have IDs less than about 3/16″, more preferably about ¼″. However, in some embodiments, the more-critical closing umbilical hose 506B will have an ID less than about 3/16″ and the less-critical opening umbilical hose 506A may be the industry-standard 3/16″ ID or larger.

In the preferred embodiment, subsea pilot-operated valves 507A, 507B, and 507C will have hydraulic actuation volumes less than about 2 cubic centimeters. However, valve 507A may be a valve with a hydraulic actuation volume much greater than 2 ccs; for example, an industry-standard shear-seal control valve.

Pilot-operated valves 507A, 507B, and 507C as shown in the embodiment of FIG. 5 preferably have a flow coefficient (Cv) equal to or greater than 1.0, which is more than one order of magnitude greater than typical pilot valves of the prior art.

Pilot-operated valves 507A and 507B are depicted here as pressure-biased by the pressure in subsea pressure piping 505E, which will typically be 3000 psi. This allows these pilot-operated valves to be biased against a relatively high baseline pressure in the umbilical hoses, but still be very compact. Alternately, of course, pilot-operated valves 507A and 507B could be spring-biased as is known in the prior art. Pilot-operated valve 507C is depicted as being biased by the combination of the pressure in the opening umbilical hose 506A and a small spring, in order to urge the valve closed when there is no pressure in either umbilical hose. Alternately, of course, pilot-operated valve 507C may be spring-biased.

Function subsystem 511 comprises SPM open valve 509A, SPM close valve 509B, SPM piping 508A and 508B, and BOP actuator 512 which has open chamber 512A and close chamber 512B.

For safety purposes (for example, in case there is a leak across pilot-operated valves 507A or 507B), the bias springs in SPM valves 509A and 509B may typically be set at an actuation pressure which is greater than the nominal baseline pressure in umbilical hoses 506A and 506B.

Surface control valves 503A and 503B are two-position, three-way, spring-biased hydraulic valves. They are schematically represented here as independent, hydraulically actuated valves, for clarity. Those of ordinary skill in the art will recognize, however, that the actuators for these valves will under almost all circumstances be coupled together such that only one valve can be opened at a time, and that the functions of surface control valves 503A and 503B may be combined in one valve if desired. Further, surface control valves 503A and 503B, or one valve combining their functions, may alternately be actuated manually, pneumatically or by other means known in the art. Alternately, they may be pressure-biased instead of spring-biased.

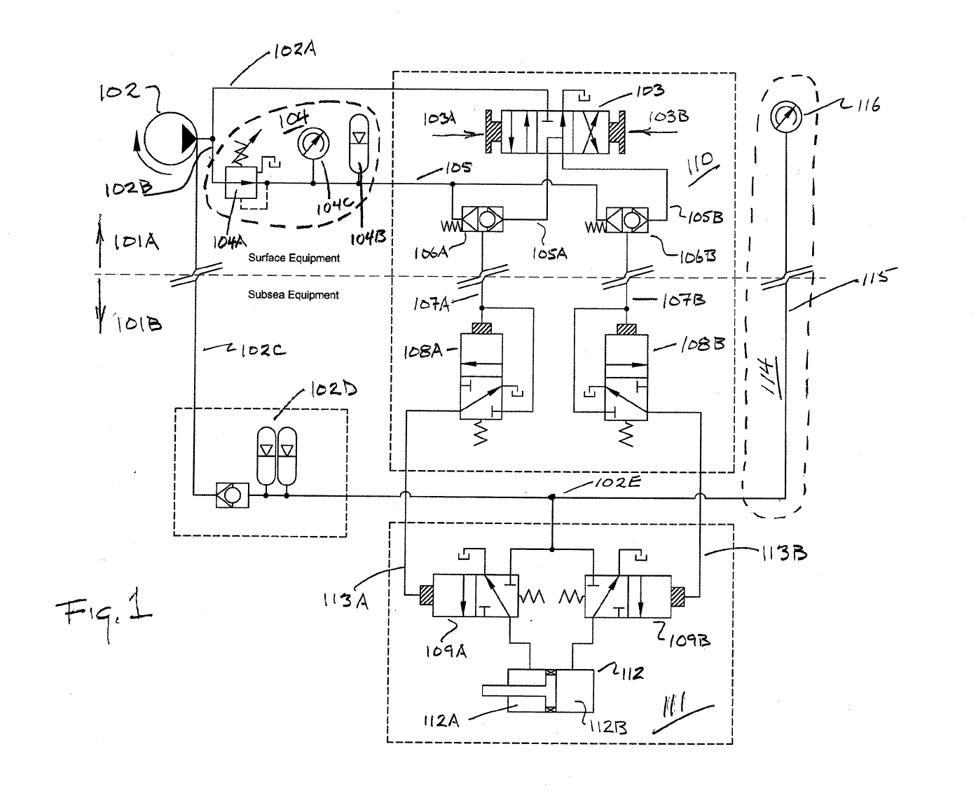

When surface control valves 503A and 503B are both in the open position as shown in FIG. 5 (equivalent to the neutral position of the system as shown in FIG. 1), baseline pressure in baseline pressure piping 502D is supplied to umbilical hoses 506A and 506B through surface control valves 503A and 503B, arranged in series.

In order to open BOP actuator 512, surface control valve 503A is opened, which vents the baseline pressure in the closing umbilical hose 506B and provides hydraulic pressure at about 3000 psi from surface piping 504C to opening umbilical hose 506A. This pressure shifts pilot-operated valve 507A, which provides hydraulic pressure from subsea pressure piping 505E to opening SPM valve 509A, which in turn supplies the same pressure to opening chamber 512A.

In order to close BOP actuator 512 from the neutral position shown, surface control valve 503B is opened, which vents the baseline pressure from the top of opening umbilical hose 506A and provides hydraulic pressure at about 3000 psi from surface piping 504C to closing umbilical hose 506B. This pressure shifts pilot-operated valve 507C, which vents baseline pressure from the bottom of opening umbilical hose 506A and insures that pilot-operated valve 507A is fully open, and thus venting SPM piping 508A. Simultaneously, this pressure also shifts pilot-operated valve 507B, which provides hydraulic pressure from subsea pressure piping 505E to closing SPM valve 509B, which in turn supplies the same pressure to opening chamber 512B.

The embodiment represented by FIG. 5 has the advantages that both opening and closing sides of the system have umbilical hoses with relatively high baseline pressure, and pilot-operated valves with very low hydraulic actuation volumes, which together may insure very low signal times in deepwater applications. These advantages may be particularly important in subsea control of production equipment such as choke valves, gate valves and ball valves, where opening and closing actuation are equally important.

This embodiment also provides for top and bottom venting of any pressure in the closing line to insure a short response time on the closing side of the system. Those of ordinary skill in the art will recognize that the hydraulic circuitry of pilot-operated valve 507C may also be applied to the opening side, in cases where opening and closing actuation are equally important.

In addition, this embodiment uses the positive actuation of surface control valves 503A and 503B to switch from baseline pressure to an actuation pressure in the umbilical hoses, rather than the slower and potentially less-reliable spring-biased shuttle valves of the prior art.

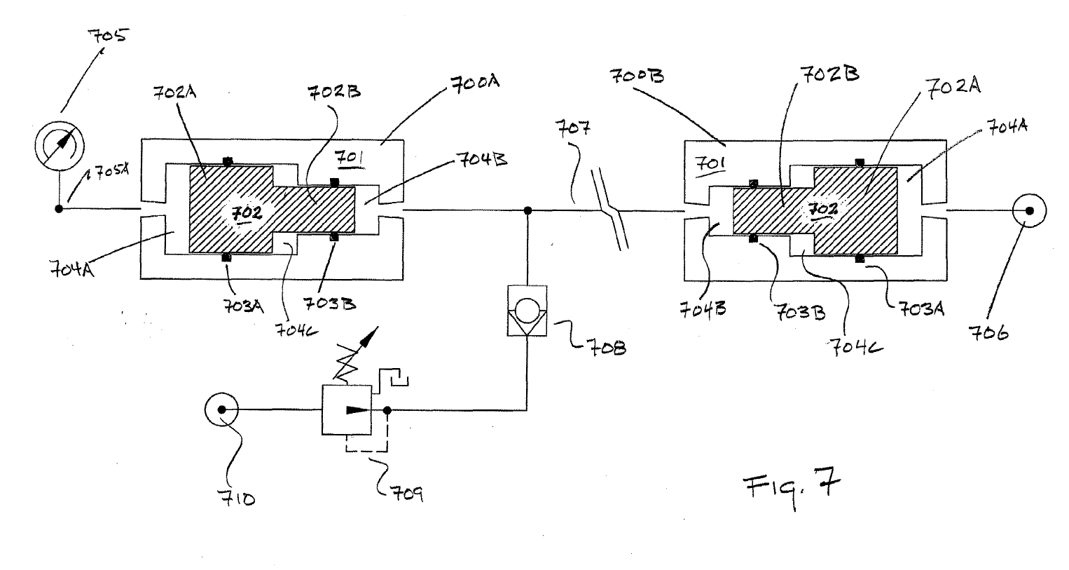

Refer now to FIG. 6, which is a schematic of another system which is an alternative preferred embodiment of the present invention. The system is divided into Surface Equipment 601A and Subsea Equipment 601B, and also divided into the Signal subsystem 610 and the Function subsystem 611. The system has separate “closing” and “opening” circuits, which are used to close and open a subsea BOP (not depicted).

The system has hydraulic pump 602, pressure regulator system 602B, and surface piping 602C supplying hydraulic pressure to surface control valve 603. Typically, pressure regulator system 602B will be set at or very near to 3000 psi.

The system also preferably has baseline pressure regulator system 604 which supplies baseline hydraulic pressure greater than 100 psi, but typically between 600 and 1500 psi, to shuttle valve 604B.

Preferably, hydraulic pressure of about 3000 psi is also supplied to subsea accumulator system 605 through subsea conduit 605A. The pressure regulator shown in subsea accumulator system 605 will conventionally be set for at or near 3000 psi. Subsea conduit 605A is typically a one inch ID jointed rigid pipe attached to the drilling riser, but it also may be a flexible hose within the BOP control umbilical, or other conduit means known in the art.

Signal subsystem 610 comprises surface control valve 603, opening umbilical hose 606A, closing umbilical hose 606B, shuttle valve 604B and subsea pilot-operated valves 607A, 607B, and 607C.

Umbilical hose 606B preferably has an ID less than about 3/16″, more preferably about ¼″. Umbilical hose 606A may have an industry-standard ID of about 3/16″, as it controls the less-critical closing function. Subsea pilot-operated valves 607A, 607B, and 607C have hydraulic actuation volumes less than 2 cubic centimeters.

Function subsystem 611 comprises SPM open valve 609A, SPM close valve 609B, SPM piping 608A and 608B, and BOP actuator 612 which has open chamber 612A and close chamber 612B.

The system of FIG. 6 has a baseline pressure in the closing umbilical hose 606B only, and is therefore cheaper to build than the system shown in FIG. 5, but it still vents the opening umbilical hose 606A from both the top (through surface control valve 603) and the bottom (through pilot-operated valve 607C).

Refer now to FIG. 7, which is a schematic of a monitoring subsystem of an embodiment of the current invention with a bias pressure applied to a pressure monitoring subsystem. As in the prior art, the Monitoring subsystem shown in FIG. 7 comprises umbilical hose 707 hydraulically connected to subsea hydraulic manifold 706, and pressure gauge 705 on the surface. However, in this embodiment, umbilical hose 707 has a bias pressure applied from hydraulic pressure source 710, through pressure regulator 709 and check valve 708. Near both distal ends of umbilical hose 707 are pressure-balancing shuttles 700A and 700B. Each pressure-balancing shuttle 700A and 700B has body 701, generally cylindrical shuttle 702 with large end 702A and small end 702B, seals 703A and 703B, low pressure cavity 704A and high pressure cavity 704B.

On pressure-balancing shuttle 700A, low pressure cavity 704A is hydraulically connected to pressure gauge 705 at the surface, and high pressure cavity 704B is hydraulically connected to umbilical hose 707. On pressure-balancing shuttle 700B, low pressure cavity 704A is connected to subsea hydraulic manifold 706, and high-pressure cavity 704B is hydraulically connected to umbilical hose 707.

This subsystem raises the pressure within umbilical hose 707 such that the differential volumetric expansion of umbilical hose 707 is minimized, and the pressure in subsea hydraulic manifold 706 is superimposed on the bias pressure.

In one preferred embodiment, the bias pressure maintained in umbilical hose 707 will be about the rated working pressure of the umbilical hose 707 minus the maximum expected pressure in the subsea manifold 706. In another preferred embodiment, the ratio between the sealing area of seal 703B and the sealing area of seal 703A will be about the ratio of the maximum expected manifold pressure plus the bias pressure, divided by the bias pressure. Typically, this ratio may be about 1.5 to 1.6.

Because an all-hydraulic monitoring subsystem such as that shown in FIG. 7 relies on the speed of the pressure rise in the entire umbilical hose 707 rather than a pressure “pulse” like the signal subsystem, umbilical hose 707 may beneficially be larger than 3/16″ in inner diameter, and have a corresponding lower Cv, provided that the hose is designed to have a low differential volumetric expansion at or near the bias pressure. In one preferred embodiment, umbilical hose 707 has an inner diameter between 3/16″ and 1″ and a differential volumetric expansion below 0.33×10⁻⁴ cc/foot of hose/psi change in internal pressure at or near the bias pressure. In another preferred embodiment, umbilical hose 707 has an inner diameter between ½″ and 1″ and a differential volumetric expansion below 0.25×10⁻⁴ cc/foot of hose/psi change in internal pressure at or near the bias pressure.

In another preferred embodiment, the ratio of seal areas of seals 703A and 703B are arranged such that, for example, a 2 psi rise in manifold pressure results in a 1 psi rise in umbilical pressure (or some other similar ratio), which allows a higher bias pressure. In this embodiment, of course, the scale on pressure gauge 705 must be adjusted to reflect the actual subsea manifold pressure.

Those persons having ordinary skill in the art will recognize that the monitoring subsystem shown in FIG. 7 may benefit from bleed-off mechanisms to, for example, bleed-off air from the surface manifold 705A or to bleed-off excess hydraulic fluid from the intermediate cavity 704C (which, for example, may leak past seals 703A and 703B). These bleed-off mechanisms are not shown for purposes of clarity.

Those skilled in the art will recognize that other circuits may be constructed without departing from the teachings of the present invention. For example, a hydraulic subsea control system may alternately comprise only one circuit (as in the case of a fail-safe subsurface safety valve with hydraulic opening and spring-operated closure).

For example, the prior art system depicted in FIG. 1 may be reconfigured according to the teachings of the present invention to comprise umbilical hose with about an ⅛″ ID, pilot-operated valves with hydraulic actuation volumes below about 2 cc, and a baseline pressure greater than 100 psi. Alternately, for example, known subsea control systems of the prior art which can control more than one function per control line, such as those taught in U.S. Pat. Nos. 3,993,100 and 4,497,369 and 4,407,183 as discussed previously, may utilize the teachings of the present invention by being reconfigured to comprise umbilical hose with an ID less than about 3/16″, pilot-operated valves with actuation volumes less than 1 cc, and a baseline pressure greater than about 600 psi.

In view of this disclosure, various other modifications may be made to the control system of the present invention by those of ordinary skill in the art without departing from the spirit of the invention. It should be understood, therefore, that the present invention is not limited to the disclosed embodiments, but that the scope of the invention includes all embodiments within the following claims.

We claim:

1. A deep water hydraulic control system, comprising:
at least one subsea pilot-operated valve having a hydraulic actuation volume less than about 2 cubic centimeters; and
an umbilical hose hydraulically connected to said valve, said hose having an inner diameter less than about 3/16 inch and containing a hydraulic fluid at an internal baseline pressure.

2. The control system of claim 1, wherein the pilot-operated control valve is spring-biased.

3. The control system of claim 1, wherein the pilot-operated control valve is biased by a regulated pressure source.

4. The control system of claim 3, wherein the ratio of the regulated pressure source to the baseline pressure is less than or equal to 3 to 1.

5. The control system of claim 3, wherein the ratio of the regulated pressure to the baseline pressure is less than or equal to 2 to 1.

6. The control system of claim 1, wherein the pilot-operated control valve is biased by a combination of spring force and a pressure source.

7. The control system of claim 1, wherein the control valve has a flow coefficient (Cv) greater than or equal to 1.0.

8. The control system of claim 1, wherein the control valve has a ratio of hydraulic actuation volume to flow coefficient (Cv) less than 100.

9. The control system of claim 1, wherein the control valve is a shuttle-type valve with an axial metal-to-metal seal.

10. The control system of claim 1, wherein the baseline pressure is selected such that the differential volumetric expansion of the hose at the selected baseline pressure is less than 1×10⁻⁴ cc/foot/psi of hose pressure.

11. The control system of claim 1, wherein the hydraulic fluid is selected for an acoustic velocity greater than 5000 feet per second.

12. The control system of claim 1, wherein the umbilical hose is located proximate the center of an umbilical bundle.

13. The control system of claim 1, wherein the umbilical hose has at least one outer fiber reinforcing layer separated from at least one inner fiber reinforcing layers by a resilient layer.

14. The control system of claim 1, wherein baseline pressure is greater than about 100 psi.

15. The control system of claim 1, wherein baseline pressure is greater than about 600 psi.

16. A one subsea pilot-operated valve comprising a valve having a hydraulic actuation volume less than about 2 cubic centimeters.
